(19) United States
(12) Patent Application Publication
(10) Pub. No.: US 2018/0150618 A1
(43) Pub. Date: May 31, 2018

(54) POROSITY SIMULATION FOR OXIDE CERAMIC MATRIX COMPOSITES

(71) Applicant: The Boeing Company, Chicago, IL (US)

(72) Inventors: Moises Nevarez, Long Beach, CA (US); Arunabh Bhattacharya, La Palma, CA (US)

(73) Assignee: The Boeing Company, Chicago, IL (US)

(21) Appl. No.: 15/363,945

(22) Filed: Nov. 29, 2016

(51) Int. Cl. G06F 19/00; C04B 35/71; C04B 35/64; G06F 17/50; G06F 17/11

(52) U.S. Cl. CPC G06F 19/704; C04B 35/71; G06F 17/11; G06F 17/5009; C04B 35/64

(57) ABSTRACT

Systems and methods for designing oxide ceramic matrix composite parts entail creating a simulation of the oxide ceramic matrix composite part based on expected processing parameters to be used to create the oxide ceramic matrix composite part as well as material characteristics of one or more materials to be used to create the part. The part so created is subjected to simulated structural testing to predict performance of a potential physical counterpart, and the physical counterpart of the simulated oxide ceramic matrix composite part is then produced if the simulated testing yields results that conform to predetermined performance requirements.

### FIELD

The present disclosure relates generally to composite structures and, more particularly, to the simulation of porosity in oxide ceramic matrix composite materials.

### BACKGROUND

In general terms, a composite material is a material made up of two or more constituents, each of which provides a certain characteristic, such that the composite material benefits to some extent from the characteristics of all of its constituents. Relevant constituent characteristics include directional characteristics such as tensile strength, flexibility, deformability, and compressive strength, as well as non-directional characteristics such weight. Well-known composite materials include carbon fiber polymeric composites, wood/foam sandwich composites and others.

One type of composite material that is of interest with respect to extreme environments is the oxide ceramic matrix composite (“CMC”). This material is created by binding a uni- or multi-directional fiber lathe in a ceramic matrix. The oxide ceramic material is generally an inorganic oxide, nitride or carbide material that is initially in the form of a slurry containing ceramic powder, water, and, in some cases, one or more binders or deflocculants. After part manufacture, the dried or cured ceramic matrix may have a variety of inclusions and voids therein, with the voids generally being referred to as “pores.”

Porosity has a significant bearing on the final part strength and longevity, and as such, the porosity values of CMC parts are of interest (herein, all ceramics and CMC matrices are oxide ceramics and matrices). However, it has traditionally been difficult to predict the porosity of such a part, and thus difficult to predict the strength or life of such a part with any accuracy, especially prior to production of the part in physical form. Of course, it is possible to produce parts while varying the process parameters and then dissect the parts to measure porosity empirically, or to examine failed parts. However, this entails the time and cost of part production, as well as the inherent waste of time and material invested in making parts that will be destructively examined and discarded.

The present disclosure is directed to methods and system that may eliminate certain shortcomings, as noted above or otherwise. However, it should be appreciated that such a benefit is neither a limitation on the scope of the disclosed principles nor of the attached claims, except to the extent expressly noted in the claims. Additionally, the discussion of technology in this Background section is reflective of the inventors' own observations, considerations, and thoughts, and is in no way intended to accurately catalog or comprehensively summarize the art currently in the public domain. As such, the inventors expressly disclaim this section as admitted or assumed prior art. Moreover, any identification or implication above or otherwise herein of a desirable course of action reflects the inventors' own observations and ideas, and should not be assumed to indicate an art-recognized desirability.

### SUMMARY

In accordance with one aspect of the present disclosure, a method for predicting structural performance of a ceramic matrix composite part entails identifying processing parameters to be used to create the ceramic matrix composite part and identifying material characteristics of at least one material to be used to create the ceramic matrix composite part. The material characteristics may include one or more characteristics associated with a slurry used to form the ceramic matrix of the ceramic matrix composite part. The final porosity of the ceramic matrix after processing is estimated based on one or more of the processing parameters and one or more of the material characteristics, and the structural performance of the part is then predicted based at least on the estimated final porosity of the ceramic matrix.

In accordance with another aspect of the present disclosure, a system for predicting structural performance of a ceramic matrix composite part includes a memory, one or more inputs, and a processor in communication with the memory and the one or more inputs. In this embodiment, the processor is configured to identify processing parameters to be used to create the ceramic matrix composite part, material characteristics of at least one material to be used to create the ceramic matrix composite part, including one or more characteristics of a slurry used to form the ceramic matrix, and to estimate a final porosity of the ceramic matrix based on one or more of the processing parameters and one or more of the material characteristics. The processor is further configured to predict structural performance of the ceramic matrix composite part based at least on the estimated final porosity of the ceramic matrix.

In accordance with yet another aspect of the present disclosure, a method of designing a ceramic matrix composite part entails creating a simulation of the part based on expected processing parameters and material characteristics, simulating structural testing of the part to predict performance of a physical counterpart of the simulated ceramic matrix composite part, and producing the physical counterpart if the simulated testing yields results in conformity with predetermined performance requirements.

The features, functions, and advantages disclosed herein can be achieved independently in various embodiments or may be combined in yet other embodiments, the details of which may be better appreciated with reference to the following description and drawings.

### BRIEF DESCRIPTION OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a schematic representation of material transport mechanism during sintering of a ceramic matric in accordance with an embodiment of the described principles;

FIG. 2 is a schematic representation of particle form progression during sintering of a ceramic matric in accordance with an embodiment of the described principles;

FIG. 3 is a set of idealized lattice schematics showing densification and coarsening of the particle matrix during sintering in accordance with an embodiment of the described principles;

FIG. 4 is a process flowchart in accordance with an embodiment of the described principles;

FIG. 5 is a parameter interrelationship chart in accordance with an embodiment of the disclosed principles;

FIG. 6 is a relational chart of associations between example process parameters, material characteristics, and resultant part properties in accordance with an embodiment of the described principles; and

FIG. 7 is a system schematic showing a computing environment in which a process in accordance with an embodiment of the described principles is executed.

It should be understood that the drawings are not necessarily to scale, and that the disclosed embodiments are illustrated diagrammatically, schematically, and in some cases in partial views. In certain instances, details which are not required or helpful for an understanding of the disclosed methods and apparatuses or which render other details difficult to perceive may have been omitted. It should be further understood that the following detailed description is merely exemplary and not intended to be limiting in its application or uses. As such, the present disclosure is for purposes of explanatory convenience only, and it will be appreciated that the disclosure may be implemented in numerous other ways, and within various systems and environments not shown or described herein.

### DETAILED DESCRIPTION

Before presenting a fuller discussion of the disclosed principles, an overview is given to aid the reader in understanding the later material. As noted above, ceramic matrix porosity has a significant bearing on the strength and longevity of CMC parts, and yet it has traditionally been difficult to predict the porosity values of CMC parts with any accuracy. As a result, it has been difficult to predict the strength, behavior, and longevity of CMC parts to be produced. This has typically caused part suppliers to incur additional design costs and inefficiencies, e.g., in the form of serial destructive testing or over-engineering.

In various embodiments of the principles described herein, a CMC porosity model relates processing and material parameters to predict porosity and thus to predict strength and life performance of a proposed CMC structure. The model accounts for porosity between and within composite plies. The processing parameters may include, inter alia, lay-up parameters, heat treat parameters, machining parameters and so on. Useful material parameters include, inter alia, slurry type and viscosity, since changes in the slurry can cause pore size and prevalence to change, and may also change the interrelationship between porosity and certain processing parameters such as temperature. The porosity parameters of interest may include pore size as well as pore number and distribution.

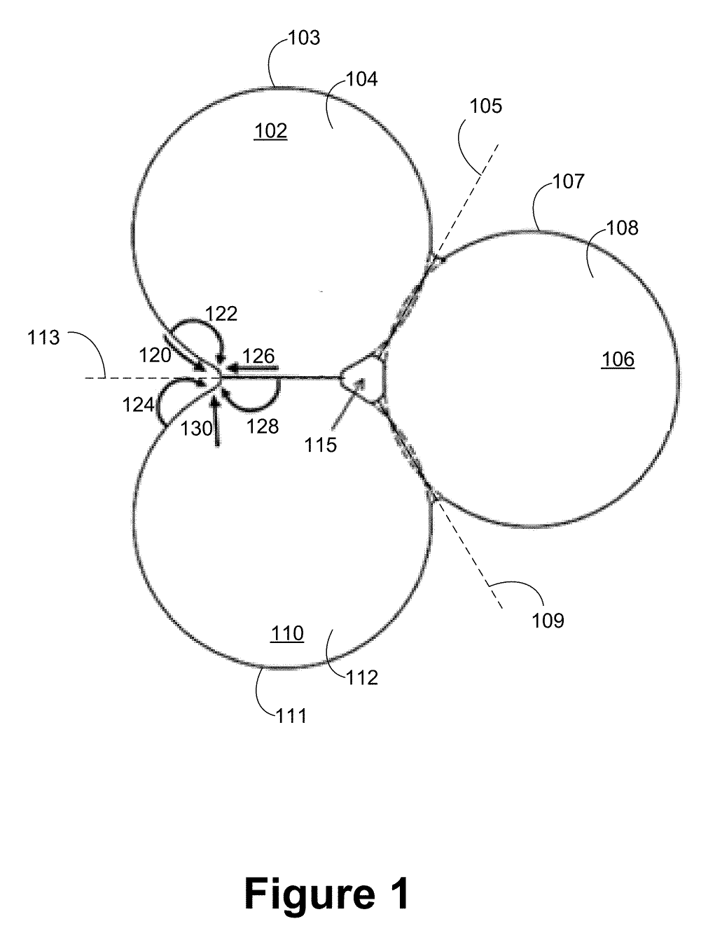

With this overview in mind, we turn to the details of various embodiments to allow a fuller understanding of the structures, techniques and considerations of interest. FIG. 1 is a schematic cross-sectional view of a collection of ceramic grains 102, 106, 110, and shows the intermediate effects of sintering on the grain boundaries and material porosity. It will be appreciated that the grains shown will typically be part of a much larger assembly of grains, but three grains are sufficient to illustrate the relevant processes.

The grains are assumed to have been initially spherical so that deformations can be more easily seen. It will be appreciated that the initial grain shape will rarely be precisely spherical, but the details of various grain shapes do not significantly impact the basic processes shown.

In the illustration, each grain 102, 106, 110 includes a respective surface 103, 107, 111 and a respective interior 104, 108, 112. Respective grain boundaries 105, 109, 113 are located where the grains 102, 106, 110 meet. A pore 115 is formed by the joining of the grain surfaces 103, 107, 111 at the grain boundaries 105, 109, 113.

The schematic drawing of FIG. 1 illustrates the qualitative impact of various transport processes on the shape and size evolution of the grains 102, 106, 110 and the pore 115. The primary transport processes are surface diffusion, lattice diffusion from the surface, vapor transport, grain boundary diffusion, lattice diffusion from the grain boundary, and plastic flow.

Surface diffusion, illustrated by arrow 120, represents the migration or diffusion of grain constituents along the surface 103, 107, 111 of a grain 102, 106, 110. Lattice diffusion from the surface, illustrated by arrow 122, represents the movement of constituents through the material lattice structure from the surface 103, 107, 111. Not all transport mechanisms remain on or within the grain, as illustrated by arrow 124, which represents the vapor transport of material.

Arrow 126 represents grain boundary diffusion, wherein material moves along the grain boundaries 105, 109, 113, and the arrow 128 shows lattice diffusion from the grain boundary; that is, movement of material away from the grain boundaries 105, 109, 113. Finally, the plastic flow of material is represented by arrow 130. Plastic flow entails the movement of material as a mass, enabled by lower viscosity resulting from the application of heat.

In general, all of these transport mechanisms contribute to change the form of each grain 102, 106, 110 and the group of grains 102, 106, 110 together during sintering. More specifically, when adjacent grains 102, 106, 110 are exposed to sufficient thermal energy, the increased molecular mobility within the grains allows each of these transport mechanisms to transport material from the noted source (e.g., grain surface 103, 107, 111, grain boundary 105, 109, 113, grain interior 104, 108, 112) to the neck areas defined by the grain boundaries 105, 109, 113.

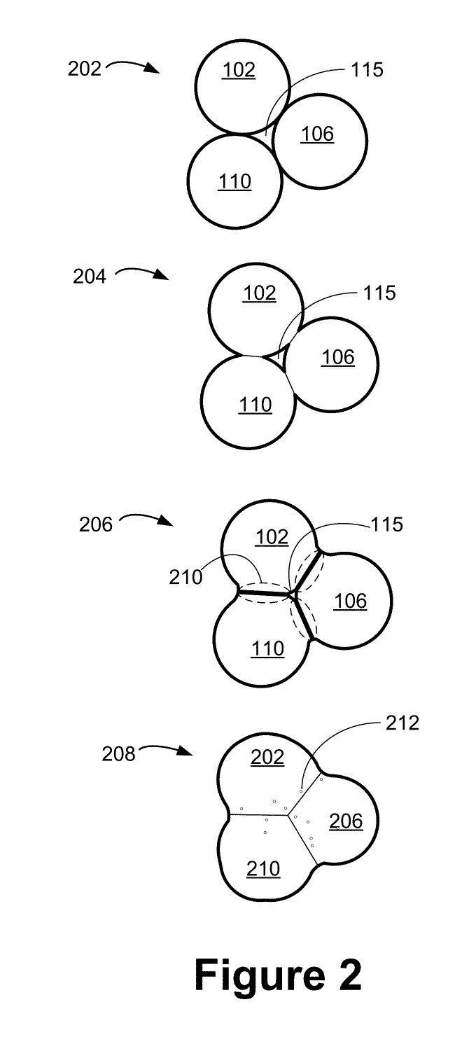

The result of these various transport processes is the eventual merging of the grains 102, 106, 110 through growth of the neck regions. The progression of the grains 102, 106, 110 from separate entities to a merged entity is shown in greater detail in FIG. 2. Although the progression is a continuum, the four illustrated stages 202, 204, 206, 208 show certain distinct points in the progression.

Stage 202 illustrates an initial stage wherein the grains 102, 106, 110 are in contact with one another but are distinct and separable entities. At this stage 202, the pore 115 is formed between the points of contact. Moving to the next stage 204, the grains are illustrated as slightly merged via the formation of necks 210 between the grains 102, 106, 110. The pore 115 is still extant but is diminished in size due to thickening of the necks 210.

Moving to the third stage 206, the necks 210 have thickened to the point that the pore 115 is almost entirely replaced by a network of open pores across the necks 210 along the grain boundaries 105, 109, 113 (FIG. 1). In the final stage 208 of the sintering process, the grain boundaries 105, 109, 113 essentially cease to exist except as theoretical constructs, and the network of open pores present at stage 206 are replaced by a dispersed network of closed pores 212.

As the sintering progresses though stages 202, 204, 206, 208, the relative density (the ratio of filled to unfilled space) of the overall matrix increases, from a relative density that is typically less than 0.65 to a relative density that typically exceeds 0.9. It should be noted that not all initial pore spaces are incorporated in the final matrix. Rather, some initial pores vent to the surrounding environment as sintering progresses.

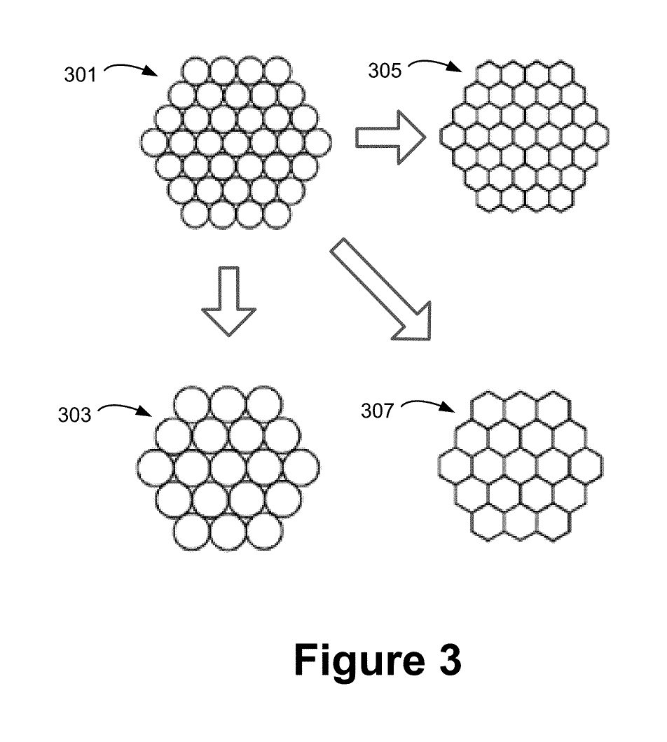

It will be appreciated that the larger matrix as a whole, may coarsen, densify, or both when sintered. These possible outcomes are shown schematically in FIG. 3. As can be seen, the initial matrix 301, when sintered, may undergo particle growth to the point of decreasing the overall number of particles as shown in state 303. In this case, the overall size of the associated part is not increased, however the individual sizes of the fewer remaining particles are larger than the initial particle size. Alternatively, the initial matrix 301 may undergo densification as shown in state 305. In this case, the associated part does experience shrinkage. Finally, the initial matrix 301 often undergoes both coarsening and densification to reach the state shown schematically as state 307, which again tends to cause some part shrinkage.

In an embodiment of the disclosed principles, the pore shrinkage within the sintered matrix is modeled to predict the final porosity (pore size and distribution) of the finished part embodying the matrix. To this end, a particle number continuity equation such as the following may employed:

$$\frac{\partial n}{\partial t} + ∇ \cdot {v}_{e} n + ∇ \cdot {v}_{i} n + D - B = 0$$

The foregoing equation can be reduced to:

$$\frac{\partial n}{\partial t} + \frac{\partial }{\partial r} ( {v}_{r} n ) = 0.$$

In these equations, n is a number density function defined in an (m+3)-dimensional space consisting of three external (spatial) coordinates and m internal coordinates (e.g., size, age, etc.). The variable t is used to represent time and vₑ(v-sub-e) represents the external (spatial) particle velocity. The variable vᵢ(v-sub-i) represents internal particle velocity, the function D represents a particle death function, and the function B is a particle birth function.

Population balance of pores is then calculated via a continuity equation such as

$$\frac{\partial {n}_{p} ( {r}_{p} , t )}{\partial t} + \frac{\partial }{\partial {r}_{p}} ( {v}_{{r}_{p}} {n}_{p} ( {r}_{p} , t ) ) = 0$$

wherein rₚ(r-sub-p in μm) is the pore radius and nₚ(rₚ, t) (in ηm⁻³ μm⁻¹) is the number density function of pores. The value nₚ(rₚ, t) drₚ represents the number of pores whose radius is between rₚ and rₚ+drₚ at sintering time t.

The pore shrinkage velocity is then calculated as

$${υ}_{{r}_{p}} = \frac{{dr}_{p}}{dt} = - \frac{{k}_{p}}{{r}_{p}^{m}}$$

wherein kₚ (k-sub-p in μm^{m+1}/h) is a rate constant and m is a model parameter related to the material transport mechanism, set by simple trial and error. The minus sign in the equation indicates a decrease in size over time (e.g., shrinkage).

In an embodiment, the rate constant kₚ is set to vary with temperature to better predict porosity. Using the known Arrhenius equation, kₚ can be described as:

$${k}_{p} ( T ) = {k}_{p 0} {e}^{- \frac{{Q}_{p}}{RT}}$$

where Qₚ(Q-sub-p in J/mol) is the activation energy for pore shrinkage (densification). The constant R (in J×K⁻¹ mol⁻¹) is the gas constant and the value T (in Kelvin) is the absolute temperature. The units of the pre-exponential factor kₚ₀ are the same as for kₚ and will vary depending on the order of the reaction. If the reaction is first order, then the units are h⁻¹ or s⁻¹.

The relationship between kₚ and absolute temperature can be described through a linear relationship to characterize Qₚ/T, which can then be used to estimate activation energy. In an embodiment, the following linear relationship is employed:

$$ln {k}_{p} = ln {k}_{p 0} - \frac{{Q}_{p}}{RT}$$

With respect to Pore Size Distribution, recall the continuity equation for pore population set forth above, and consider an initial pore size distribution of

nₚ(rₚ(0), 0)=n₀(r₀)

where r₀=rₚ(0), the pore size at time zero.

The initial pore size distribution can be estimated to be a log-normal distribution described by

$${n}_{0} ( r ) = \frac{1}{{r}^{4} \sqrt{2 π} ln σ} {e}^{- \frac{1}{2} {( \frac{ln r - ln {r}_{m}}{ln σ} )}^{2}}$$

where rₘ(r-sub-m) is the median size and a is the geometric standard deviation. In an embodiment, image analysis may be employed to set values for the mean radius of pores and the standard deviation value.

Within the composite part or product, three types of porosity can be modelled. The first porosity type stems from lay-up technique, de-bulking (reducing air inclusions via vacuum on pre-cured lay-up, forcing trapped gases from between layers), and FEP removal (FEP is Fluorinated ethylene propylene, a fluoropolymer resin similar to TEFLON that is used to separate wet layup layers prior to layup). Empirically, the size distribution for this type of porosity is 500 μm with a mean area of 547.63 μm and a sigma of 787.97 μm. Of course, as with the two other examples below, these sizes are given as examples, and techniques or materials will result in different numbers. Indeed, in an embodiment, the process described herein can model the reduction or growth of pore diameters to control the final composite properties.

The second type of porosity is intra-fabric porosity, which is dependent on impregnation parameters such as blade height (of the blade used to force the matrix into the layup weave), packing density, and particle size. Empirically, the size distribution for this type of porosity is 70 μm with a mean 88.61 μm and a sigma of 206.25 μm. The third type of porosity is inherent porosity, which forms and changes during curing or sintering and which is thus dependent upon the material system used and the thermal profile used to finish the part. Empirically, the size distribution for this type of porosity is 2 μm with a mean of 1 μm and a sigma of 1.62 μm.

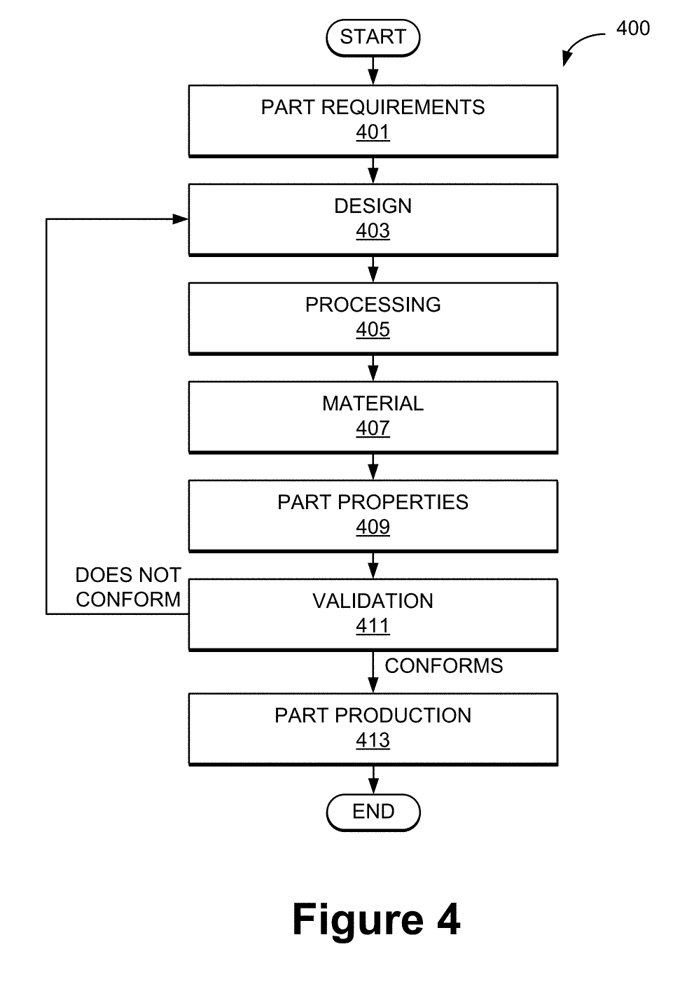

With the models and value determinations discussed above, the part creation process can now be modelled and tested virtually as shown in FIG. 4. More specifically, FIG. 4 is a process stage diagram showing the various stages of iterative design and virtual testing in an example embodiment to yield a completed physical part. In overview, the process 400 entails first delineating the part requirements, at stage 401, e.g., deformation, mechanical load, thermal load, LCF/HCF/TMF, creep, oxidation, chemical resistance, FOD (foreign object damage), erosion resistance, dimensional qualities, tolerances, repair capabilities and cost.

Next, at stage 403, the part design data is provided, e.g., the aero/thermal design, the mechanical design, the heat transfer properties, stress analysis, dynamic analysis and life prediction. The part processing parameters are added at stage 405, including, for example, parameters such as fiber type, weave type, lay-up technique, interface coating, matrix properties (e.g., CVI (chemical vapor infiltration), SI (silicon infiltration), MI (melt infiltration)), seal coat, heat treat, machining, EBC (electron beam coating) and NDE (nondestructive examination).

In an embodiment, three stages of sintering are modeled. These include an initial stage, an intermediate stage, and a final stage. The stages can be delineated by the process temperature level, with the initial stage representing temperatures early in the process with little movement, the intermediate stage representing a stage part way through the process where there is significant molecular mobility but little plastic flow, and the final stage represents the last portion of the process wherein there is significant plastic flow.

The model input parameters include temperature profile, particle size, particle distribution, pressure, particle packing, and composition. The constituents are assigned a category such as solid-state, liquid phase, vitrification, and viscous. The dominant transport mechanisms in each phase are then assigned, e.g., vapor transport, surface diffusion, lattice diffusion, grain boundary diffusion, and dislocation motion. The process model is linked to structural analysis. In particular, the results of the process model are input to structural analysis routines to determine porosity distribution based on the above porosity models as well as weave architecture, and matrix distribution.

Given the design and processing information, the material effects can thus be generated at stage 407, e.g., the fiber structure (orientation, 2d vs 3D, etc.), any damaged or broken fibers, tow/fabric misalignment, FM (fiber matrix) interphase, pores/cracks (e.g., size, distribution, location), delamination, EBC CMC bond coat, coating microstructure and surface texture. From these material effects, the part properties can be derived at stage 409, e.g., part stiffness, thermos/physical properties, ply strength (PL), ultimate tensile strength (UTS), interlaminar tensile strength (ILT), interlaminar shear strength (ILS), residual stress, interfacial strength, toughness, fatigue/creep, environmental durability, bond strength, FOD/Erosion resistance, and resultant cost.

In an embodiment, the structural analysis follows a finite element model (FEM) process for predicting the life and strength of the oxide composite matrix composite structure. As will be appreciated, the FEM process entails representing a structure as a collection of state vectors and force vectors to predict resultant strength, deformation, etc. For example, a state vector of displacement may be driven by a force vector of mechanical force, and a state vector of temperature may be driven by a force vector of heat flux. In this way, the part can be modelled as a whole or as a collection of parts which are themselves FEM modelled.

As noted above, process parameters of a CMC layup structure may be obtained by predicting porosity of the ceramic slurry between the CMC layup structure such that the processing parameters are independently related to the porosity prediction of the slurry, and relating structural performance the CMC layup structure to the porosity prediction of the slurry. The processing parameters may include a fiber architecture, weaving, layup, interface coating, delamination, heat treat, machining, and surface texture, and the relating of the structural performance of the CMC layup structure to the porosity prediction may then be performed by characterizing material properties in the FEM model.

Subsequent to modeling, the part is validated at stage 411, meaning that the part properties are compared to the part requirements. The validation stage 411 may include coupon testing, fiber/bundle testing, preform testing, fiber push (in/out) testing, sub-element testing, rig testing and engine testing. If the simulated part properties indicate conformance to the part requirements, then the part may be considered ready to produce, and the process 400 flows to stage 413 for physical part production. Otherwise, the process 400 returns to stage 403 to repeat this and subsequent stages for the application of design changes, processing changes or material changes, and for re-modelling and re-validation.

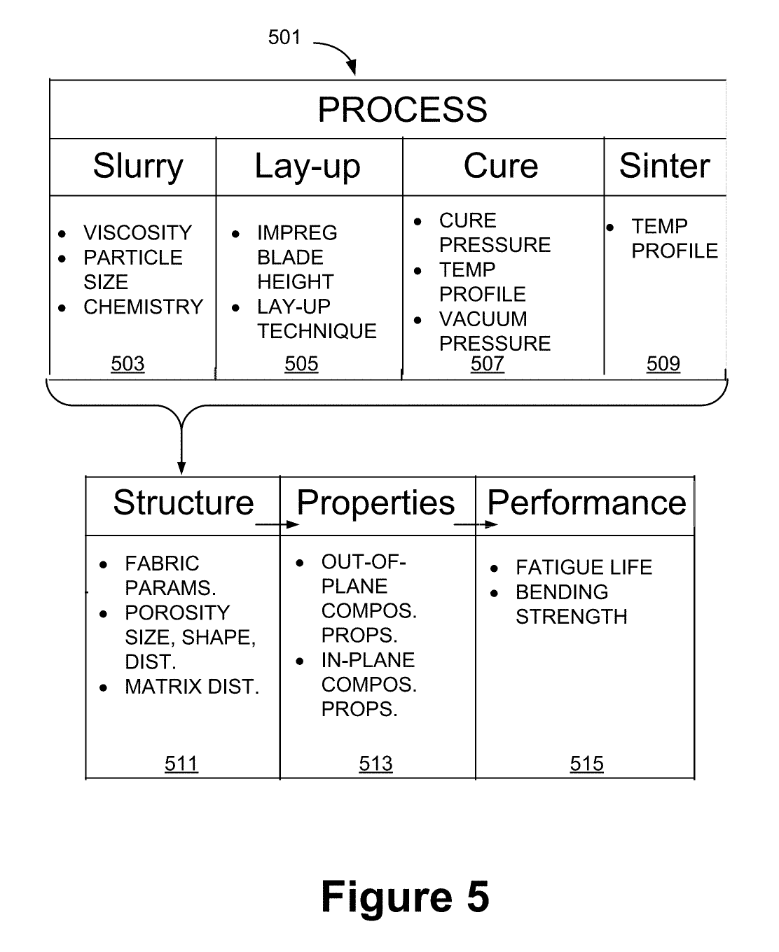

An example of the parameter interrelationships in accordance with an embodiment of the disclosed principles is shown in FIG. 5. This example uses certain process parameters and other values pertinent to an example part, but it will be appreciated that the types of parameters may vary depending upon the nature of the part in question.

As shown, the process parameters 501 include slurry characteristics 503, lay-up characteristics 505, cure characteristics 507, and sinter characteristics 509. The slurry characteristics 503 include viscosity, particle size, and chemistry, while the lay-up characteristics 505 relate to the manner in which the ceramic oxide slurry is introduced to the fabric, e.g., impregnation blade height, and the manner in which layers are constructed, e.g., lay-up technique.

With respect to the cure characteristics 507, these include cure pressure, cure temperature profile and vacuum pressure. Although cure pressure and vacuum pressure are both pressures, the former represents a physical force applied to the part during curing, while the latter represents a level of vacuum drawn on the part to remove entrained air and so on. Finally, the sinter characteristics include, in the illustrated example, the sintering temperature profile, or temperature as a function of time.

The process characteristics 501, including the slurry characteristics 503, lay-up characteristics 505, cure characteristics 507, and sinter characteristics 509, are then utilized to simulate the resultant structure data 511, including characteristics such as fabric parameters, matrix porosity size, shape and distribution, and matrix distribution. From the simulated structure, properties 513 are derived, e.g., out-of-plane and in-plane composite properties. Based on these properties, the performance data 515 for the part is then simulated for subsequent validation as discussed above.

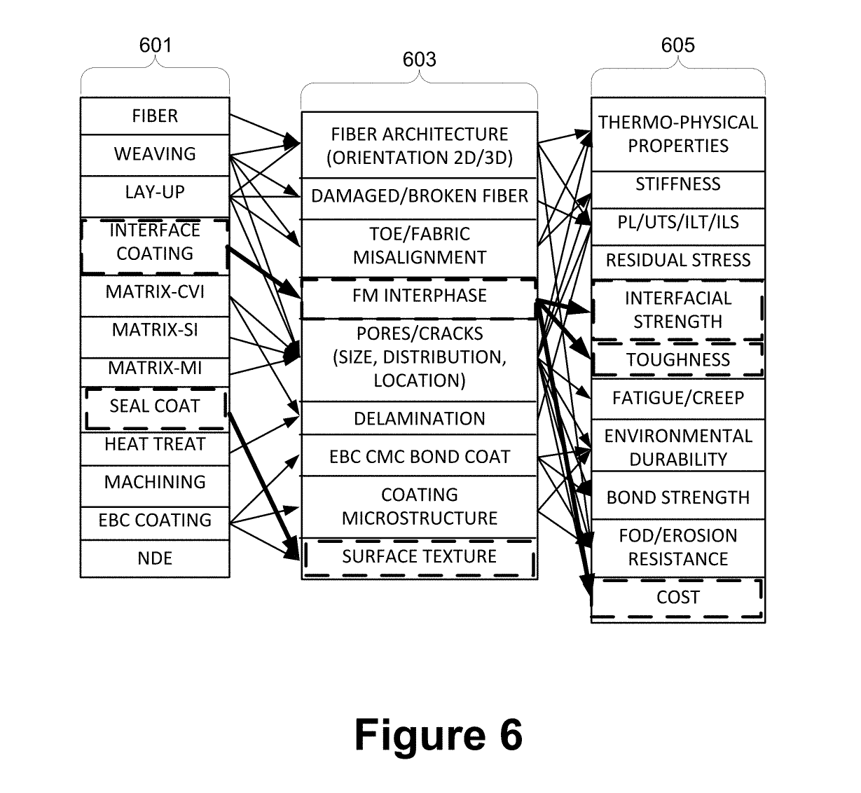

Turning to FIG. 6, this figure shows a relational chart of associations between example process parameters 601 (see also FIG. 4 stage 405), material characteristics 603 (see also FIG. 4 stage 407), and resultant part properties 605 (see also FIG. 4 stage 409) respectively. In overview, almost all processing parameters 601 are associated with one or more corresponding material characteristics 603, except for the processing parameters of machining and NDE. Similarly, almost all material characteristics 603 are associated with one or more corresponding resultant part properties 605, except for the material characteristic of surface texture.

Looking more closely at the process parameters 601, in the example these include fiber, weaving, lay-up, interface coating, matrix-CVI, matrix-SI, matrix-MI, seal coat, heat treat, machining, EBC coating and NDE. Similarly, the material characteristics 603 in the illustrated example include fiber architecture (orientation, 2D/3D), damaged/broken fiber, toe/fabric misalignment, FM interphase, pores/cracks (size, distribution, location), delamination, EBC CMC bond coat, coating microstructure, and surface texture. The resultant properties 605 in the illustrated example include thermo-physical properties, stiffness, PL/UTS/ILT/ILS, residual stress, interfacial strength, toughness, fatigue/creep, environmental durability, bond strength, FOD/erosion resistance, and cost.

The link lines shown in the figure signify the potential relationships between various values or properties. For example, the process parameter of “interface coating” influences the material characteristic of “FM interphase,” which in turn impacts the part properties of “interfacial strength,” “toughness,” and “cost.” In contrast, the process parameter of “seal coat” influences the material characteristic of “surface texture,” but has no impact on any part property of interest in this example.

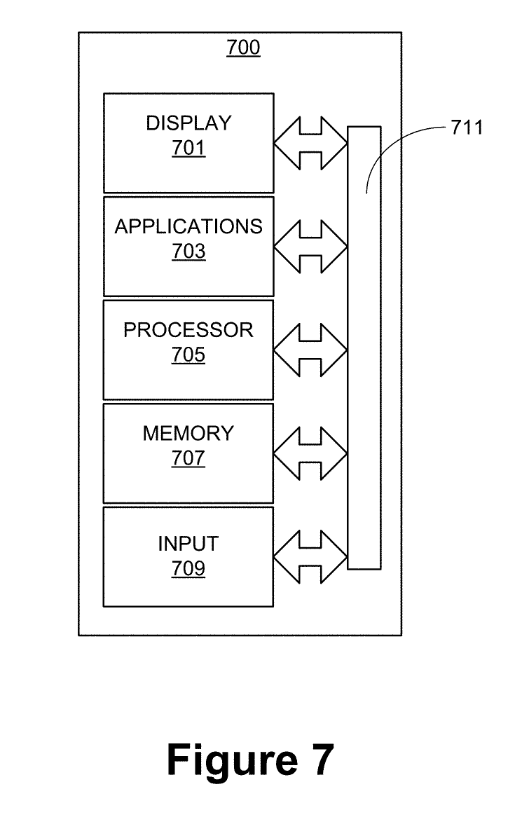

FIG. 7 is a simplified system schematic showing salient features of a computing environment in which processes in accordance with embodiments of the described principles may be executed. In the flow chart of FIG. 4, for example, the steps that execute modelling are performed on a computing device that executes the prescribed steps by retrieving (reading) computer-executable instructions, e.g., code or programs, from a non-transient computer-readable medium, such as an optical or magnetic drive, flash drive, RAM (random access memory, ROM (read-only memory) etc., and executing the retrieved instructions via a processor.

Thus, the system 700 shown in FIG. 7 includes a display screen 701, applications (e.g., programs) 703 and a processor 705. The processor 705 may be any of a microprocessor, microcomputer, application-specific integrated circuit, and like structures. For example, the processor 705 can be implemented by one or more microprocessors or controllers from any desired family or manufacturer.

The system 700 also includes a memory 707, which may be, but need not be, resident on the same integrated circuit as the processor 705. Additionally or alternatively, the memory 707 may be accessed via a network, e.g., via cloud-based storage. The memory 707 may include a random access memory (i.e., Synchronous Dynamic Random Access Memory (SDRAM), Dynamic Random Access Memory (DRAM), RAIVIBUS Dynamic Random Access Memory (RDRM) or any other type of random access memory device or system) or a read only memory (i.e., a hard drive, flash memory or any other desired type of memory device).

The information that is stored in the memory 707 can include program code associated with one or more operating systems or applications as well as informational data, e.g., program parameters, process data, etc. For example, the applications 703 and their intermediate execution values and parameters, may be, but need not be, stored in the memory 707. An operating system and the applications 703 are typically implemented via executable instructions stored in a non-transitory computer readable medium (e.g., memory 707) to control basic functions of the system 700. Such functions may include, for example, interaction among various internal components and storage and retrieval of applications and data to and from the memory 707.

One or more input components 709 such as speech or text input facilities are included in the illustrated system 700 to allow interaction with the system 700 by a user. In an embodiment, the input components 709 include a physical or virtual keyboard maintained or displayed on a surface of the device or a surface associated with the device.

Further with respect to the applications 703, these may utilize the operating system to provide more specific functionality, such as file system services and handling of protected and unprotected data stored in the memory 707. Although some applications 703 may provide standard or required functionality of the device 700, in other cases applications 703 provide optional or specialized functionality.

Finally, with respect to informational data, e.g., program parameters and process data, this non-executable information can be referenced, manipulated, or written by the operating system or an application 703. Such informational data can include, for example, data that are preprogrammed into the device during manufacture, data that are created by the device or added by the user, or any of a variety of types of information that are uploaded to, downloaded from, or otherwise accessed at servers or other devices with which the system 700 is in communication during its operation.

All or some of the internal components communicate with one another by way of one or more shared or dedicated internal communication links 711, e.g., an internal bus. In an embodiment, the device 700 is programmed such that the processor 705 and memory 707 interact with the other components of the device 700 to perform certain functions. The processor 705 may include or implement various modules and execute programs for initiating different activities such as the computer-implemented stages of the process described herein.

It will be appreciated that example systems and techniques for oxide ceramic matrix composite porosity simulation have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Moreover, while some features are described in conjunction with certain specific embodiments, these features are not limited to use with only the embodiment with which they are described, but instead may be used together with or separate from, other features disclosed in conjunction with alternate embodiments.

What is claimed is:

1. A method (400) for predicting structural performance of an oxide ceramic matrix composite part (300) having an oxide ceramic matrix composite layup structure, the method comprising:
identifying (405) processing parameters (501) to be used to create the oxide ceramic matrix composite part;
identifying (407) material characteristics (513) of at least one material to be used to create the oxide ceramic matrix composite part, including one or more characteristics associated with a slurry (202) to form the oxide ceramic matrix (208) of the oxide ceramic matrix composite part;
estimating (409) final porosity of the oxide ceramic matrix after processing based on one or more of the processing parameters and one or more of the material characteristics; and
predicting (409) structural performance of the oxide ceramic matrix composite part based at least on the estimated final porosity of the oxide ceramic matrix.

2. The method in accordance with claim 1, wherein the structural performance of the oxide ceramic matrix composite part includes part life and part strength.

3. The method in accordance with claim 1, further comprising receiving (401) one or more part requirements and comparing (411) the predicted structural performance of the oxide ceramic matrix composite part to the one or more part requirements.

4. The method in accordance with claim 3, further comprising determining (411) that the predicted structural performance of the oxide ceramic matrix composite part does not conform to all of the one or more part requirements, and in response receiving a change (403) to one or more of the processing parameters or (405) one or more of the material characteristics and repeating the steps of estimating, predicting and comparing.

5. The method in accordance with claim 1, further comprising producing (413) the oxide ceramic matrix composite part using the identified processing parameters and the identified material characteristics.

6. The method in accordance with claim 1 wherein the processing parameters include one or more of fiber architecture, weaving, layup, interface coating, delamination, heat treat, machining, and surface texture.

7. The method in accordance with claim 1 wherein predicting structural performance of the oxide ceramic matrix composite part based at least on the estimated final porosity of the oxide ceramic matrix is performed via an FEM (finite element model).

8. The method in accordance with claim 1 wherein the estimated final porosity of the oxide ceramic matrix includes an estimated pore size and an estimated pore distribution, and wherein estimating final porosity of the oxide ceramic matrix is performed via a pore shrinkage model.

9. The method in accordance with claim 8 wherein the pore shrinkage model estimates effects due to sintering of a slurry to form the oxide ceramic matrix.

10. A system (700) for predicting structural performance of an oxide ceramic matrix composite part (300) having an oxide ceramic matrix composite layup structure, the system comprising:
a memory (707);
one or more inputs (709);
a processor (705) in communication with the memory and the one or more inputs and configured to identify (405) processing parameters (501) to be used to create the oxide ceramic matrix composite part, identify (407) material characteristics (513) of at least one material to be used to create the oxide ceramic matrix composite part, including one or more characteristics associated with a slurry (202) to form the oxide ceramic matrix (208) of the oxide ceramic matrix composite part, estimate (409) a final porosity of the oxide ceramic matrix after processing based on one or more of the processing parameters and one or more of the material characteristics, and predict (409) structural performance of the oxide ceramic matrix composite part based at least on the estimated final porosity of the oxide ceramic matrix.

11. The system in accordance with claim 10, wherein the structural performance of the oxide ceramic matrix composite part includes part life and part strength.

12. The system in accordance with claim 10, wherein the processor is further configured to receive (401) one or more part requirements and compare (411) the predicted structural performance of the oxide ceramic matrix composite part to the one or more part requirements.

13. The system in accordance with claim 12, wherein the processor is further configured to determine (411) that the predicted structural performance of the oxide ceramic matrix composite part does not conform to all of the one or more part requirements, and in response to receive a change (403) to one or more of the processing parameters or (405) one or more of the material characteristics and to then repeat estimating, predicting and comparing.

14. The system in accordance with claim 10 wherein the processing parameters include one or more of fiber architecture, weaving, layup, interface coating, delamination, heat treat, machining, and surface texture.

15. The system in accordance with claim 10 wherein the processor is further configured to predict structural performance of the oxide ceramic matrix composite part based at least on the estimated final porosity of the oxide ceramic matrix via an FEM (finite element model).

16. The system in accordance with claim 10 wherein the estimated final porosity of the oxide ceramic matrix includes an estimated pore size and an estimated pore distribution, and wherein the processor is further configured to estimate final porosity of the oxide ceramic matrix via a pore shrinkage model.

17. The system in accordance with claim 16 wherein the pore shrinkage model models effects due to sintering of a slurry to form the oxide ceramic matrix.

18. A method (400) of designing an oxide ceramic matrix composite part (300) having an oxide ceramic matrix composite layup structure, the method comprising:
creating a simulated oxide ceramic matrix composite part based on expected processing parameters (501) to be used to create the oxide ceramic matrix composite part and on material characteristics (513) of at least one material to be used to create the oxide ceramic matrix composite part;
simulating structural testing of the simulated oxide ceramic matrix composite part to predict performance of a physical counterpart of the simulated oxide ceramic matrix composite part; and
producing the physical counterpart of the simulated oxide ceramic matrix composite part if the simulated structural testing yields results in conformity with predetermined performance requirements.

19. The method in accordance with claim 18, wherein the material characteristics of at least one material include one or more characteristics associated with a slurry (202) to form the oxide ceramic matrix (208) of the oxide ceramic matrix composite part.

20. The method in accordance with claim 18, wherein creating the simulated oxide ceramic matrix composite part comprises estimating (409) a final porosity of the oxide ceramic matrix after processing.
